(19) United States
(12) Patent Application Publication
(10) Pub. No.: US 2014/0095985 A1
(43) Pub. Date: Apr. 3, 2014

(54) ARRANGING DIGITAL RECEIPT ITEMS

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/631,443

(22) Filed: Sep. 28, 2012

(51) Int. Cl. G06F 17/00

(52) U.S. Cl. 715/243

(57) ABSTRACT

The present invention extends to methods, systems, and computer program products for arranging digital receipt items at a mobile device. A customer's digital receipts are stored at a mobile device. Receipt items are accessed from one or more stored digital receipts. Each receipt item includes item information for a purchased item. The plurality of receipt items are displayed in a first display arrangement at a display of the mobile device. A user request is received to change the first display arrangement. The user request includes arrangement criteria indicating how the plurality of receipt items is to be rearranged for display. In response to the user request, a second display arrangement is formed in accordance with the arrangement criteria. The plurality of receipt items are displayed in the second display arrangement at the display.

### CROSS-REFERENCE TO RELATED APPLICATIONS

Not applicable.

### BACKGROUND

1. Field of the Invention

This invention relates generally to the field of electronic sales transactions, and, more particularly, to arranging digital receipt items at a mobile device.

2. Related Art

In a variety of transactions, consumers or buyers of goods or services typically receive receipts from their respective merchants or service providers as proof of existence of conducted transactions. Generally, receipts are issued by merchants and service providers for a number of reasons including, for example, regulatory or tax reasons and convenience purposes. A receipt provides information about a corresponding transaction for the purpose of providing all participants with a trace or record of the transaction. Receipts can later be used by a consumer for various purposes including, for example, proving participation in a transaction for tax reporting purpose, product returns, use as a claim ticket for a further transaction, provisioning warranties, etc. Depending on a variety of factors, such as, for example, items being purchased, business or personal purchase, amount of purchase, etc., a consumer may desire an electronic receipt and/or a paper receipt.

For in-store purchases, consumers generally obtain a paper receipt at the point-of-sale. However, some point-of-sale systems also support the delivery of digital receipts at the point-of-sale. Further, for telephone or online purchases digital receipts are typically delivered to a customer.

However, receipt deliver mechanisms are somewhat rigid and may not allow a user to configure desired receipt types (e.g., digital and/or paper) for use at checkout. For example, a conventional point-of-sale (“POS”) system typically includes a POS terminal, one or more peripheral devices (display monitor, receipt printer, barcode scanner, weigh scale, electronic signature pad) and a payment processor with pin pad (for credit and debit cards). The data for sales transactions is usually stored in a storage device of the POS terminal, which may be uploaded to one of the remote transaction authorization server or another remote server of the credit/debit card companies. Although POS systems are well equipped for merchants to monitor and collect transaction data from the POS system, the ability of the customer to input or extract useful information from the POS system is typically limited to pinpad interactions (entering tip amounts, obtaining additional cash back, etc.), and obtaining printed receipts, the format and content of which has been pre-determined by the merchant.

Even when digital receipts are generated, the digital receipts may be in a pre-configured format that is not adjustable. For example, digital receipts can be images of paper receipts that are provided to a customer at the POS system. The digital receipts can include a store identifier, a receipt identifier, a date and time of purchase, and various receipt items having item identifiers and item information. The receipt items are typically listed sequentially based on their scan order (i.e., the order the cashier scanned the items). Since the digital receipt is an image file, a customer is limited to viewing receipt items in the same sequential order.

Some POS systems may be capable of generating digital receipts as separate digital data. However, POS systems are typically sold with a proprietary on-board software system that may be specific to the merchant's business. The merchant is able to make minor programming adjustments to add discount codes and other special offers, but has limited ability to add functionality to the POS system. Thus, even if digital receipts are provided as separate digital data, a customer typically has limited, if any, ability to change how a digital receipt is viewed.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates arranging digital receipt items.

FIG. 3 illustrates a flow chart of an example method for arranging digital receipt items.

FIG. 4 illustrates an example of arranging digital receipt items.

FIG. 5 illustrates an example schematic block diagram of a point-of-sale (“POS”) system that creates digital receipts.

FIG. 6 illustrates an example schematic block diagram of a network of point-of-sale (“POS”) systems that creates digital receipts.

### DETAILED DESCRIPTION

The present invention extends to methods, systems, and computer program products for arranging digital receipt items. In the following description of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

It is further noted that, where feasible, functions described herein can be performed in one or more of: hardware, software, firmware, digital components, or analog components. For example, one or more application specific integrated circuits (“ASICs”) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

In general, embodiments of the invention are directed to (re)arranging receipt items for display on a mobile device. The arrangement of items can take place at the mobile device or at a network (e.g., Web) server. A customer mobile device receives and stores one or more digital receipts. The one or more digital receipts correspond to transactions conducted with a merchant. Prior to or after receiving the one or more digital receipts, receipt items from the one or more digital receipts can be arranged in existing (and possibly default) groupings and/or orders, such as, for example, the order items were scanned at checkout or some other user selected order. A user can select arrangement criteria (e.g., grouping and sorting criteria) for changing the arrangement of receipt items from the one or more digital receipts.

The arrangement criteria can be applied to the receipt items to rearrange the receipt items from the existing groupings and/or orders into different groupings and/or orders. The receipt items can be displayed in the different groupings and/or orders at a mobile device display. Arrangement criteria can be used to group and/or sort receipt items by price, department, tax, brand, etc. In some embodiments, receipt items from a plurality of digital receipts are rearranged into different groupings and/or orders.

Accordingly, mobile device users can rearrange receipt items as desired to more efficiently perform specified tasks. For example, a user may wish to know how much was spent on groceries over a number of visits to a merchant. As such, the user can select arrangement criteria to group receipt items from a plurality of digital receipts by department and calculate a total price for the receipt items in each grouping.

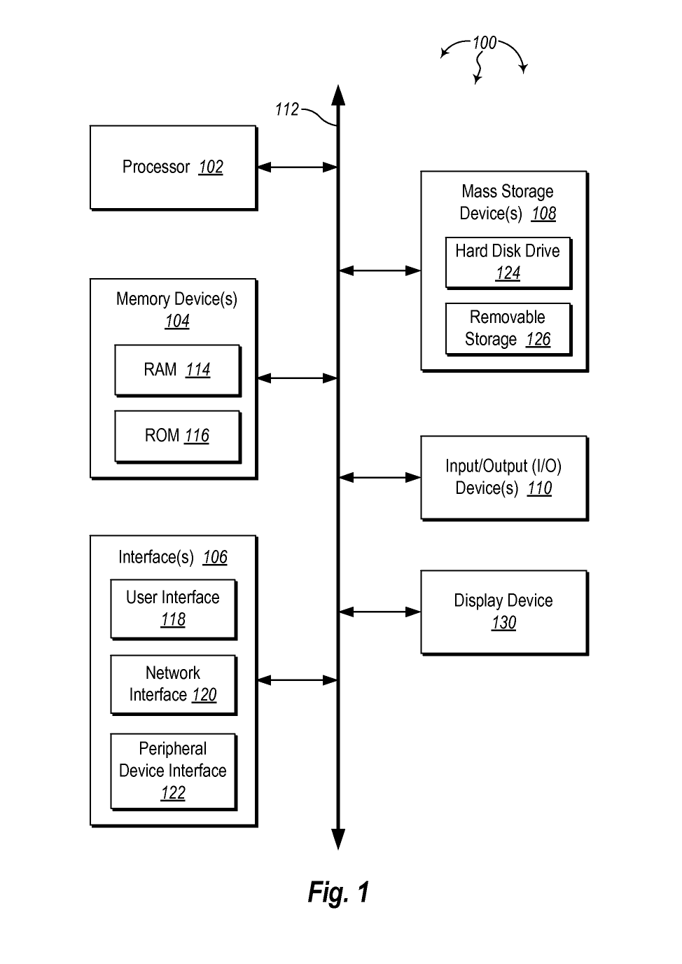

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (“RAM”) 114) and/or nonvolatile memory (e.g., read-only memory (“ROM”) 116). Memory device(s) 104 may also include rewritable ROM, such as Flash memory.

Mass storage device(s) 108 include various computer readable media, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 can include any number of different network interfaces 120, such as interfaces to personal area networks (“PANs”), local area networks (“LANs”), wide area networks (“WANs”), wireless networks (e.g., near field communication (“NFC”), Bluetooth, Wi-Fi, etc. networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

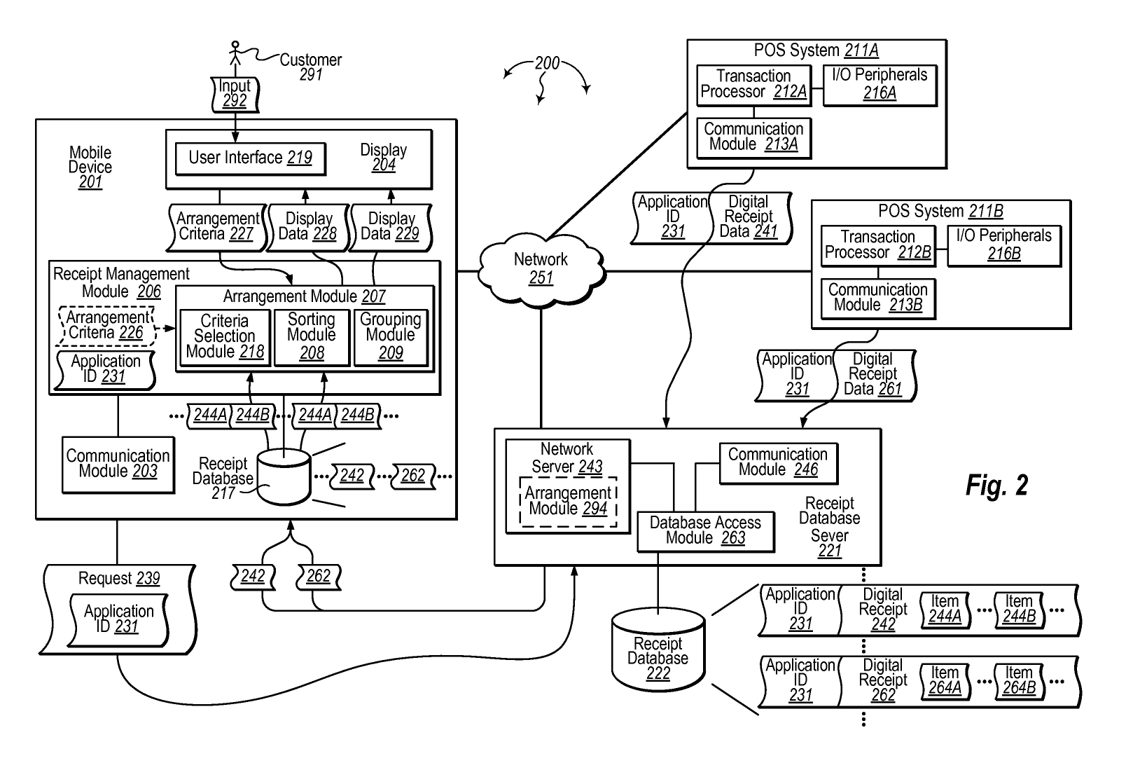

FIG. 2 illustrates an example computer architecture 200 that facilitates arranging digital receipt items. Referring to FIG. 2, computer architecture 200 includes mobile device 201, POS systems 211A and 211B, and receipt database server 221. Each of the depicted components can be connected to one another over (or be part of) a network, such as, for example, a PAN, a LAN, a WAN, and even the Internet. Accordingly, each of the depicted components as well as any other connected computer systems and their components, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

POS system 211A includes transaction processor 212A, communication module 213A, and I/O peripherals 216A. POS system 211A can be physically located at a checkout lane in a store. Generally, transaction processor 212A is configured to manage sales transactions for POS 211A. Transaction processor 212A can receive input from I/O peripherals 216A to open a sales transaction, collect receipt data (e.g., date, time, item, number of units, cost data, tax, department, etc.) for a sales transaction, and close a sales transaction. Receipt data for an item (e.g. item description, item cost, department, etc.) can be retrieved from an item database in response to scanning a barcode on (or otherwise identifying) the item. Other receipt data for an item (e.g., number of units, tax, etc.) can be calculated by transaction processor 212A. I/O peripherals 216A can include one or more of: a monitor (e.g., a cashier-facing monitor), one or more input devices (e.g., scanners, keyboards, scales, or the like), one or more payment devices (e.g., cash drawers, card readers, etc.) for receiving or returning payments, and one or more output devices (e.g., customer-facing display or monitor, receipt printer, etc.).

Communication module 213A can be a wired and/or wireless network adapter for connecting POS system 211A with a network, such as, for example, a Wi-Fi and/or wired Ethernet network, that facilitates a further connection to network 251 (e.g., the Internet).

POS system 211A can be in a physical store location that is owned by an entity, such as, for example, a retailer corporation that runs a chain of stores. The chain of stores can include one or more of: grocery stores, department stores, warehouse stores, discount stores, etc. In embodiments, POSA system 211 includes components in a checkout isle as well as components in a store based data center.

POS system 211B includes transaction processor 212B, communication module 213B, and I/O peripherals 216B. The components of POS system 211B can operate similarly to the components of POS system 211A. POS system 211B can also be in a physical store location that is owned by the entity. POS system 211A and POS system 211B can at the same or different physical locations.

Receipt database server 221 includes Network (e.g., Web) server 243, communication module 246, and database access module 263. Network server 243 is configured to communicate with external devices, such as, for example, mobile device 201. A common entity, such as, a retailer corporation, can own one or more physical store locations (e.g., a chain of stores) as well as receipt database server 221. Each of the one or more store physical locations can include one or more POS systems as well as other computer systems (e.g., local backend servers). Communication module 246 can be configured to communicate with POS systems as well as other computer systems at each of the one or more physical store locations (e.g., on an internal corporate network) to facilitate business operations for the entity.

Receipt database server 221 can receive application identifiers and digital receipt data from POS systems at various different store locations, including POS systems 211A and 211B. Receipt database server 221 can formulate digital receipts from received receipt data. Formulated digital receipts can include entries for items included in corresponding digital receipt data (but potentially in a different format, for example, a format deliverable to mobile devices). Database access module 263 can store digital receipts along with application identifiers in receipt database 222. The application identifiers map digital receipts to corresponding mobile devices. Application identifiers can be indicated, either manually by a customer in an automated fashion by a mobile device, at the time of a transaction.

For example, receipt database server 221 can receive application ID 231 along with digital receipt data 241 from POS system 211A. Similarly, receipt database server 221 can receive application ID 231 along with digital receipt data 261 from POS system 212A. Receipt database server 221 can formulate digital receipts 242 and 262 from digital receipt data 241 and 261 respectively. Digital receipt 242 includes receipt entries for items 244A, 244B, etc. Receipt items 244A, 244B, etc. correspond to physical items purchased during a transaction at POS system 211A. Digital receipt 262 includes receipt entries for items 264A, 264B, etc. Receipt items 264A, 264B, etc. correspond to physical items purchased during a transaction at POS system 211B. Digital receipts 242 and 262 can be stored along with application ID 231 to indicate that digital receipts 242 and 262 correspond to mobile device 201.

In some embodiments, receipt database server 221 is part of a (e.g., regional, national, or global) backend system that receives receipt data from a plurality of POS systems distributed throughout different geographic locations and formulates corresponding digital receipts. The plurality of POS systems and the backend system can be part of a commonly owned and/or controlled corporate network infrastructure.

Subsequent to storing digital receipts, receipt database server 221 can send stored digital receipts to customer computing devices, such as, for example, smartphones and/or tablets. Receipt database server 221 can send digital receipts to a mobile device in response to a request and/or in accordance with configured settings. For example, in response to a request for receipts from mobile device 201, receipt database server 221 can send digital receipts 242 and 262 to mobile device 201. Sending digital receipts from receipt database server 221 to a mobile device can involve push or polled mechanisms. Receipt database server 221 can send digital receipts in a web or native view.

As depicted, mobile device 201 (e.g., a smartphone) communication module 203, display 204, receipt management module 206, and receipt database 217. In general, receipt management module 206 provides a user of mobile device 201 with various mechanisms for managing their digital receipts. Receipt management module 206 further includes arrangement module 207. Arrangement module 207 is configured to arrange receipt items from one or more digital receipts as desired by a user of mobile device 201. Receipt management module can also be used to pair customer application ID 231 (e.g., derived from a loyalty number, a telephone number, a portion of a credit card number, etc.) with mobile device 201. As such, electronic receipts corresponding to application ID can be delivered to mobile device 201.

Receipt management module 206 can present user-interface 219 at display 204 (e.g., a general purpose display device). User-interface 206 can include (e.g., touch screen) user-interface controls allowing a user to select receipt item arrangement criteria. Selected receipt item arrangement criteria can be used by arrangement module 207 to (re)arrange receipt items for presentation at user interface 206. For example, customer 291 can enter input 292 to select arrangement criteria requesting that receipt items from two digital receipts be (re)arranged to form a new arrangement. The new arrangement can order receipt items in the two receipts from the highest price to the lowest price. Arrangement module 207 can apply the selected arrangement criteria to the two digital receipts to formulate the highest price to lowest price arrangement of receipt items. The highest price to lowest price arrangement can be then be presented at user interface 219.

Thus, a user request for a desired receipt item (re)arrangement can be accomplished by selecting arrangement criteria through user interface 291. The arrangement criteria are sent to arrangement module 207. Arrangement module 207 applies the arrangement criteria to receipt items from one or more digital receipts to formulate the desired receipt item (re)arrangement. The desired receipt item (re)arrangement can then be presented at user interface 219.

As depicted, arrangement module 207 includes sorting module 208, grouping module 209, and criteria selection module 218. Sorting module 208 is configured to sort receipt items in accordance with arrangement criteria. Grouping module 209 is configured group receipt items in accordance with arrangement criteria. Selection criteria module 218 can present user interface controls to facilitate arrangement criteria selection by a user. Selection criteria module 218 can receive arrangement criteria selected through the presented user interface controls.

Prior to selection of arrangement criteria, receipt items can be presented at user interface 219 in a default arrangement. A default arrangement can be the order receipt items are stored in receipt database 217 (which many in turn be the order physical items were scanned during a transaction). In some embodiments, a user can enter default arrangement criteria (e.g., through configuration settings) that are used in absence of other arrangement criteria. For example, customer 291 can select arrangement criteria 226 as default arrangement criteria. Arrangement criteria 226 can be persisted in receipt management module 206. Arrangement criteria 226 can be used to arrange receipt items for display at user interface 219, for example, when receipt management module 206 is started up or when other arrangement criteria have not been selected.

Receipt management module 206 can have receipt update functionality. From time to time, a user of mobile device 201 can use the receipt update functionality to request digital receipts from database server 221. For example, customer 291 can utilize the receipt update functionality to cause request 239 to be sent from to receipt database server 221. Request 239 can be sent to receipt database server 221 by way of communication module 203, network 251 or other known communication links. Request 239 includes application ID 231 and can also include other information such as a date range for the receipts, store identifier or other information. Application ID 231 can be used at receipt database server 221 to identify digital receipts corresponding to mobile device 301.

In response to request 239, database access module 263 can used application ID to identify digital receipts 242 and 262 within database 222. Database access module 263 can retrieve digital receipts 242 and 262 from receipt database 222. Receipt database server receipt database server 221 can return digital receipts 242 and 262 to mobile device 201. Digital receipts 242 and 262 can be sent to mobile device 201 by way of communication module 203, network 251 or other known communication links. Digital receipts 242 and 262 can be stored in receipt data 217.

Communication module 203 can be a wireless network adapter for connecting mobile device 201 with a wireless network, such as, for example, Wi-Fi and/or a cellular network (e.g., CDMA, GSM, iDen, etc.) that facilitates a further connection to network 251 (e.g., the Internet)

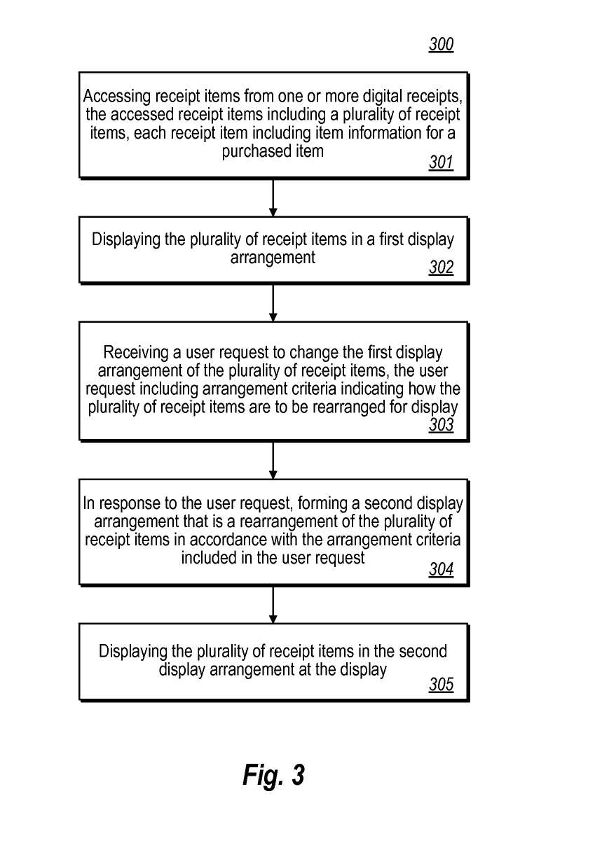

FIG. 3 illustrates a flow chart 300 of an example method 300 for arranging digital receipt items. Method will be described with respect to the components and data in computer architecture 200.

In general, method 300 can be used to form a rearrangement of receipt items for presentation at display 204, such as, the screen of a mobile phone or tablet, based on arrangement criteria. A user (customer) can view receipt items presented in a first arrangement. The user may then desire that at least some of the presented receipt items be rearranged into a second arrangement. The user can select arrangement criteria defining the second arrangement. The arrangement criteria can be applied to the at least some of the items to formulate the second arrangement. The second arrangement can then be presented at display 204 for viewing.

Method 300 includes accessing receipt items from one or more digital receipts, the accessed digital receipt items including a plurality of receipt items, each receipt item including item information for a purchased item (301). For example, arrangement module 207 can access receipt items 242A, 242B, etc. and receipt items 262A, 262B, etc. from receipt database 217. Each of receipt items 242A, 242B, etc. and receipt items 262A, 262B, etc. include item information (e.g., price, description, number of units, department, etc.) for a purchased item. Receipt items 242A, 242B, etc. correspond to items purchased at POS system 211A. Receipt items 262A, 262B, etc. correspond to items purchased at POS system 211B.

Receipt items 242A, 242B, etc. and receipt items 262A, 262B, etc. can be accessed automatically or in response to a user request. For example, customer 291 can request receipt items for a desired data range. Alternately, receipt items 242A, 242B, etc. and receipt items 262A, 262B, etc. can be accessed when receipt management module 206 is initiated, such as, for example, stored from a previous session.

Method 300 includes displaying the plurality of receipt items in a first display arrangement (302). For example, arrangement module 207 can formulate display data 228. Receipt manage module 206 can present display data 228 at display 204 (possibly within user interface 219). Display data 228 can include an arrangement of receipt items 242A, 242B, etc. and receipt items 262A, 262B, etc. The arrangement of receipt items 242A, 242B, etc. and receipt items 262A, 262B, etc. in display data is in accordance with default arrangement criteria, such as, for example, arrangement criteria 226 or the storage order of receipt items 242A, 242B, etc. and receipt items 262A, 262B, etc. in receipt database 217.

In some embodiments, receipt items receipt items 242A, 242B, etc. and receipt items 262A, 262B, etc. are presented in a tabular form and have an appearance similar to a paper receipt (e.g., that can be printed POS system 211A and/or POIS system 221B). Receipt items from different receipts can appear distinct from one another such that each receipt appears as an individual receipt distinct from each of the other receipts. For example, display data 228 can include data for displaying digital receipts 242 and 262 separately from one another in a format corresponding paper receipts. In other embodiments, other arrangements of receipt items can be displayed.

Method 300 includes receiving a user request to change the first display arrangement of the plurality of receipt items, the user request including arrangement criteria indicating how the plurality of receipt items are to be rearranged for display (303). For example, customer 291 can submit input 292 to request rearrangement of at least some of receipt items 242A, 242B, etc. and receipt items 262A, 262B, etc. Input 292 can be received at user interface 219. Within user interface 219, criteria selection module 218 can present user interface controls for selecting arrangement criteria. Criteria selection module 218 can present user interface controls for multiple different selectable arrangement criteria (e.g., data, price, description, department, tax, number of units, etc.) that can be selected by a customer. Criteria selection module 218 can present any of a wide variety of different user interface controls in different combinations, including, but not limited to: check boxes, radio buttons, lists, drop down lists, combo boxes, text boxes, date pickers, option buttons, sliders, etc.

As such, different combinations of a plurality of different sorting arrangement criteria and/or grouping arrangement criteria can be selected. As such, customer 291, through input 292, can select arrangement criteria 227 using the presented user interface controls. Criteria selection module 218 can receive arrangement criteria 227. Arrangement criteria 227 can define how at least some of receipt items 242A, 242B, etc. and receipt items 262A, 262B, etc. are to be rearranged for presentation at display 204. Arrangement criteria 227 can define that receipt items are to be sorted and/or grouped based one or more of: date, item price, item description, item department, item brand, item tax, item number of units purchased, etc. For example, customer 291 may want to view only items that cost more than a predetermined amount or may want to view only items associated with the automotive department.

Criteria selection module 218 can pass appropriate arrangement criteria 227 to each of sorting module 208 and grouping module 209.

Method 300 includes, in response to the user request, forming a second display arrangement that is a rearrangement of the plurality of receipt items in accordance with the arrangement criteria included in the user request (304). For example, arrangement module 207 can form display data 229 in accordance with arrangement criteria 227. Display data 229 represents a rearrangement of display data 228. Sorting module 208 and grouping module 209 can interoperate to resort and regroup receipt items 242A, 242B, etc. and receipt items 262A, 262B, etc. in response to and in accordance with the selection of arrangement criteria 227. Arrangement module 207 can formulate display data 229 from resorted and regrouped receipt items 242A, 242B, etc. and receipt items 262A, 262B, etc.

Method 300 includes displaying the plurality of receipt items in the second display arrangement at the display (305). For example, arrangement module 207 can present display data 229 at display 204 (possibly within user interface 219).

At times, a customer may desire to confirm that receipt information stored on his mobile device is up-to-date. In order to confirm that a mobile device has up-to-date receipts for each purchase from a merchant, the customer may request digital receipts from receipt database server 221. For example, as described, mobile device 201 can send request 239 to receipt database server 221. In response, receipt database server can return digital receipts 242 and 262. In some embodiments, receipt management module 206 automatically requests new receipts in response to a selection of new arrangement criteria. Thus, even if a user has not manually requested receipts, a (re)arrangement of receipts items can include updated receipt items.

In some embodiments, network server 243 also includes an arrangement module, such as, for example, arrangement module 294. Arrangement module 294 can include a criteria selection module, sorting module and grouping module (similar to criteria selection module 218, sorting module 208, and grouping module 209). Arrangement module 294 can be a standalone module or can interoperate with arrangement module 207 to arrange receipt items for display at mobile device 201. Arrangement module 294 can include a web based user interface. A user, for example, customer 291 can interact with arrangement module 294 through the web based user interface. Arrangement module can provide a mobile web view of arranged receipt items to back mobile device 201.

For example, customer 291 can select arrangement criteria through a Web based interface provided by arrangement module 294. The arrangement criteria can be sent to arrangement module via network communication. A sorting module and/or grouping module at arrangement module 294 can then sort and/or group receipt items at receipt database server 221. The sorted and/or grouped receipt items can be returned to mobile device 201 via network communication for presentation in a mobile web view.

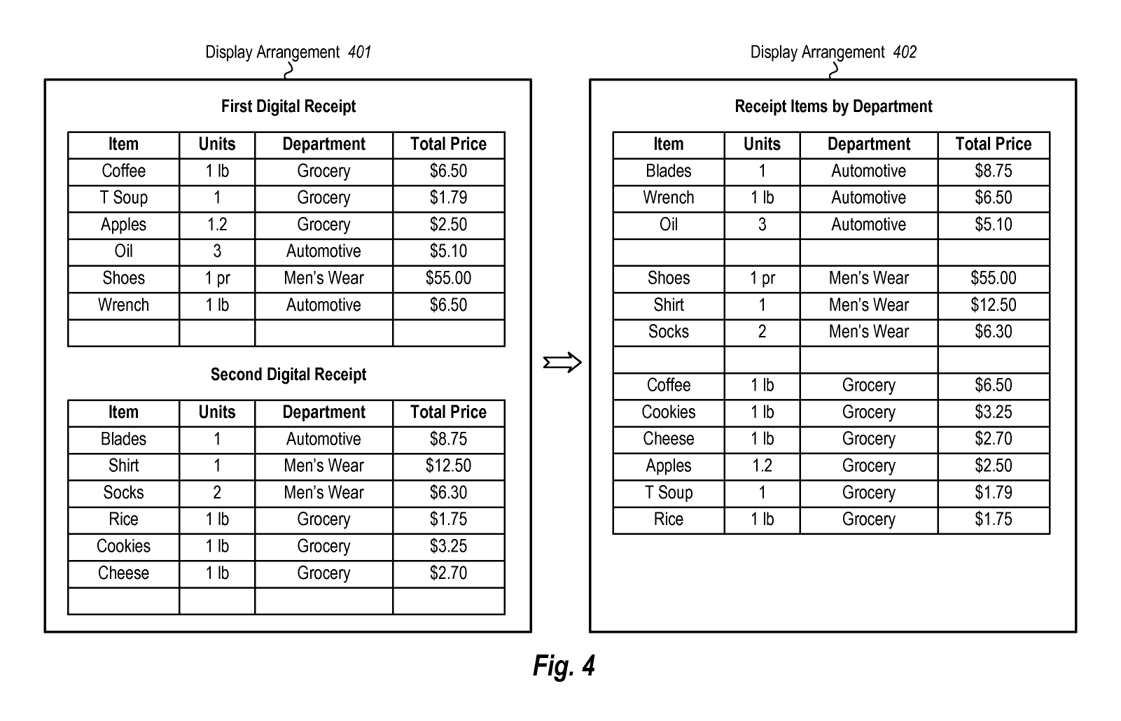

Turning to FIG. 4, FIG. 4 includes display arrangement 401. Display arrangement 401 is an example display of a first arrangement receipts (e.g., as presented at display 204). Display arrangement 401 depicts a first digital receipt having several items and item information and a second digital receipt having several items and item information. For the example, the items information includes an item name, such as, for example, coffee. Also included in the item information is the number of units, the department (which may be assigned by a merchant), and the total price of each item. In other examples other item information may be includes, such as, for example, a Universal Product Code (UPC), a name of the manufacture, the date of manufacture, an expiration date the product, a period of warranty, contact information of the manufacturer, a product weight, and other additional information. Such other and additional information can be associated with arrangement criteria.

Still referring to FIG. 4, FIG. 4 includes display arrangement 402. Display arrangement 402 is an example of a display after arrangement criteria (e.g., arrangement criteria 227) has been selected and applied to the receipt items in display arrangement 401. Display arrangement 402 includes the receipt items depicted in display arrangement 401. As depicted in display arrangement 402, receipt items are grouped by department and items within the departments are sorted by price.

The transition from display arrangement 401 to display arrangement 402 can occur locally at mobile device 201. Alternately, the transition from display arrangement 401 to display arrangement 402 can occur at receipt database server 221 and can be provided to mobile device 201 in mobile web view.

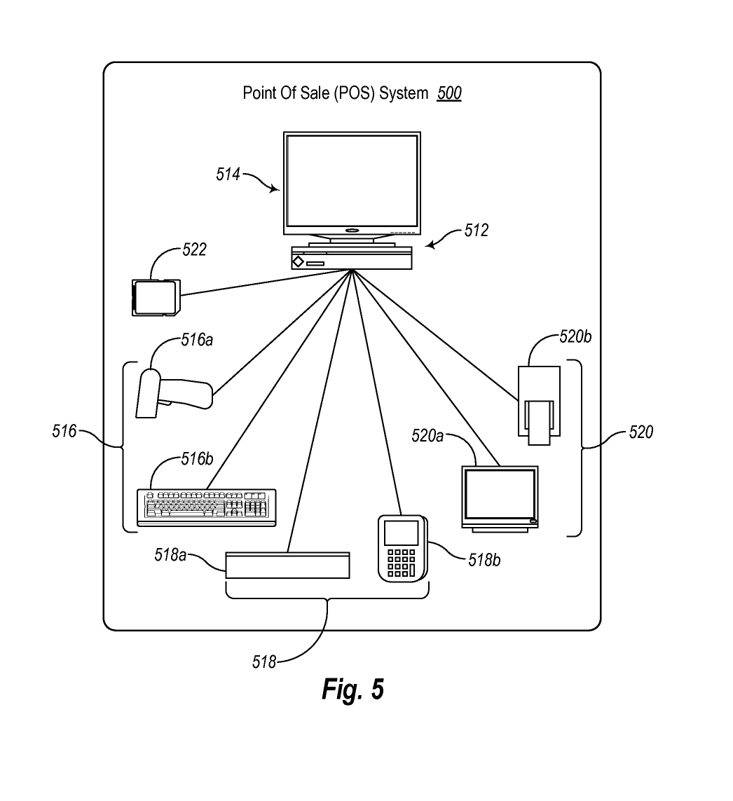

Turning to FIG. 5, FIG. 5 illustrates an example schematic block diagram of a point-of-sale (POS) system 500. In some embodiments, the hardware, software, or hardware and software of POS system 500 may be configured to implement one or more methods in accordance with the present invention. For example, POS system 500 may be manufactured, programmed, modified, or upgraded to support transferring digital receipt data to mobile devices. Any of POS systems 211A and 211B can be a POS system similar to POS system 500.

POS system 500 can include various components. In some embodiments, POS system 500 includes a central or primary computer 512, a monitor 514 (e.g., a cashier-facing monitor 514), one or more input devices 516 (e.g., scanners 516a, keyboards 516b, scales, or the like), one or more payment devices 518 (e.g., cash drawers 518a, card readers 518b) for receiving or returning payments, one or more output devices 520 (e.g., customer-facing display 520a or monitor 520a, receipt printer 520b), or the like or combinations or sub-combinations thereof, and NFC module 522, such as, for example, an NFC dongle.

Computer 512 may form the backbone of POS system 500. Other components 516, 518, 520, 522 forming part of a POS system 500 can communicate with computer 512. Input devices 516 and certain payment devices 518 can feed data and commands to computer 512 for processing or implementation. For example, scanner 516a can pass data communicating the identity of one or more items to be purchased, returned, or the like to a computer 512. Similarly, card reader 518b can pass payment information to computer 512.

On the other hand, output devices 520 and certain payment devices 518 can follow or implement commands issued by computer 512. For example, cash drawer 518a may open in accordance with the commands of computer 512. Similarly, customer-facing display 520a and receipt printer 520b can display or output data or information as instructed by computer 512.

In some embodiments, in addition to handling consumer transactions (e.g., purchases, returns), POS system 500 can provide or support certain “back office” functionality. For example, POS system 500 can provide or support inventory control, purchasing, receiving and transferring products, or the like. POS system 500 can also store sales and customer information for reporting purposes, marketing purposes, receivables management, trend analysis, cost analysis, price analysis, profit analysis, or the like. If desired or necessary, POS system 500 can include an accounting interface to pass certain information to one or more in-house or independent accounting applications.

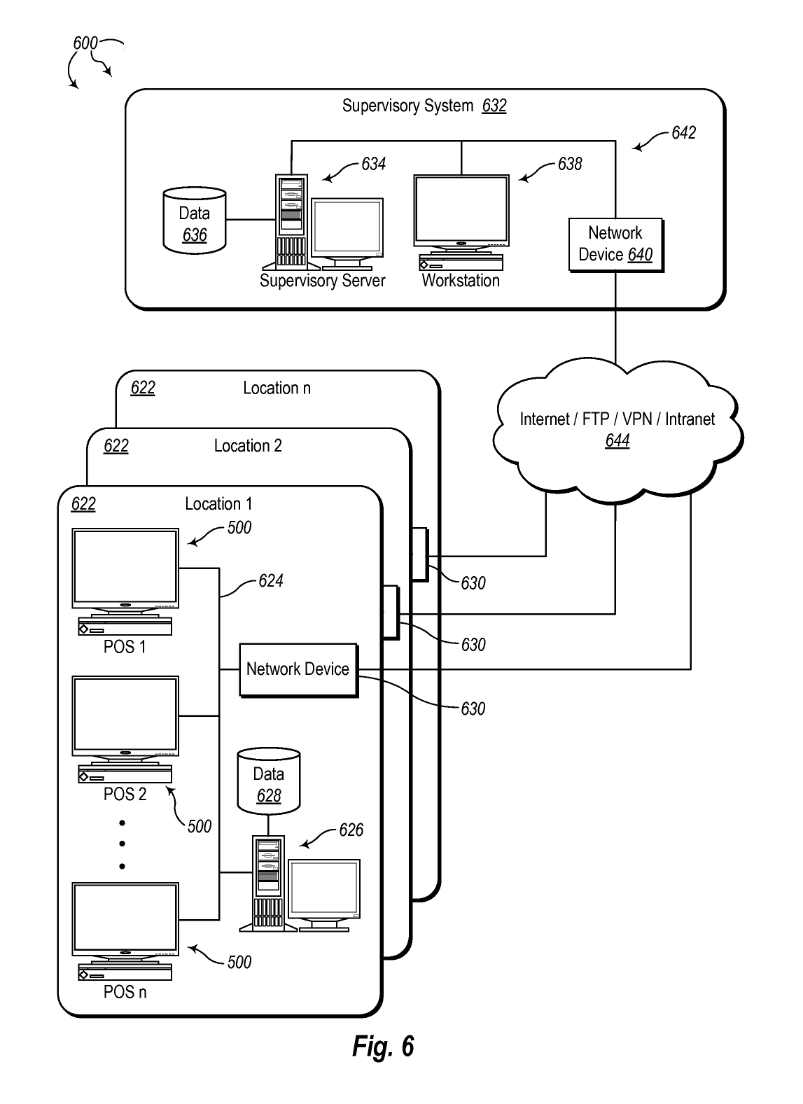

In some embodiments, POS system 500 operates substantially independently, as a stand-alone unit. Alternately, POS system 500 may be one of several POS systems 500 forming the front line of a larger system. FIG. 6 illustrates an example schematic block diagram of a network 600 of point-of-sale (POS) systems 500. For example, multiple POS systems 500 may operate at a particular location 622 (e.g., within a retail, brick-and-mortar store). In such embodiments, the various POS systems 500 may be interconnected via LAN 624. LAN 624 may also connect the POS systems 500 to a local server 626.

Local server 626 can support the operation of the associated POS systems 500. For example, a server 626 may provide a central repository from which certain data needed by the associated POS systems 500 may be stored, indexed, accessed, or the like. Server 626 can serve certain software to one or more POS systems 500. In certain embodiments, a POS system 500 can offload certain tasks, computations, verifications, or the like to server 626.

Alternatively, or in addition thereto, server 626 can support certain back office functionality. For example, server 626 can receive and compile (e.g., within an associated database 628) data from the various associated POS systems 500 to provide or support inventory control, purchasing, receiving and transferring products, or the like. Server 626 can also receive and compile sales and customer information for reporting purposes, marketing purposes, receivables management, trend analysis, cost analysis, price analysis, profit analysis, or the like.

In some embodiments, one or more POS systems 500 and/or servers 626 corresponding to a particular location 622 can communicate with or access one or more remote computers or resources via one or more network devices 630. For example, a network device 630 can enable a POS system 500 to contact outside resources and verify the payment credentials (e.g., credit card information) provided by a customer. A network device 630 can comprise a modem, router, or the like.

In selected embodiments, POS systems 500 operate within an enterprise-wide system 631 comprising multiple locations 622 (e.g., branches 622 or stores 622). In such embodiments, each location 622 may have one or more POS systems 500, local servers 626, local databases 628, network devices 630, or the like or combinations or sub-combinations thereof connected by a computer network (e.g., a LAN 624). It may be that any data receipt server 221 is included in and/or include the functionality of a local server 626.

Additionally, each such location 622 may be configured to interact with one or more supervisory systems 632. For example, multiple branch locations 622 may report to an associated “headquarters” location or system. It may be that data receipt server 221 is included in and/or include the functionality of a supervisory system 632.

A supervisory system 632 can include one or more supervisory servers 634, databases 636, workstations 638, network devices 640, or the like or combinations or sub-combinations thereof. The various components of a supervisory system 632 can be interconnected via a computer network (e.g., a LAN 642). In selected embodiments, a supervisory system 632 includes one or more supervisory servers 634 providing a central repository from which certain data needed by the one or more POS systems 500 or local servers 626 may be stored, indexed, accessed, or the like.

Alternatively, or in addition thereto, a supervisory server 634 can receive and compile (e.g., within an associated database 636) data from the various associated POS systems 500 or local servers 626 to provide or support inventory control, purchasing, receiving and transferring products, or the like. A supervisory server 634 may also receive and compile sales and customer information for reporting purposes, marketing purposes, receivables management, trend analysis, cost analysis, price analysis, profit analysis, or the like.

A supervisory system 632 can be connected to one or more associated locations 622 or branches 622 in via any suitable computer network 644 (e.g., WAN 644). For example, in selected embodiments, one or more locations 622 can connect to a supervisor system 632 via the Internet. Communication over such a network 644 can follow any suitable protocol or security scheme. For example, communication may utilize the File Transfer Protocol (FTP), a virtual private network (VPN), intranet, or the like.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. At a mobile device of a customer, the mobile having a processor, system memory, and a display, a method of arranging the display of receipt items from one or more digital receipts, the method comprising:
accessing receipt items from one or more digital receipts, the receipt items including a plurality of receipt items, each receipt item including item information for a purchased item;
displaying the plurality of receipt items in a first display arrangement;
receiving a user request to change the first display arrangement of the plurality of receipt items, the user request including arrangement criteria indicating how the plurality of receipt items are to be rearranged for display;
in response to the user request, forming a second display arrangement that is a rearrangement of the plurality of receipt items in accordance with the arrangement criteria included in the user request; and
displaying the plurality of receipt items in the second display arrangement at the display.

2. The method of claim 1, wherein item information for the plurality of receipt items includes an item price and an arrangement criteria comprises ordering receipt items by the item price.

3. The method of claim 1, wherein item information for the plurality of receipt items includes an item department and an arrangement criteria comprises placing receipt items in one or more groups where each group corresponds to a respective item department.

4. The method of claim 1, wherein, each receipt item has an item identifier, an item price, an item department, and an item date of purchase.

5. The method of claim 4, further comprising:
requesting additional item information based on an item identifier; and
receiving and storing the additional item information.

6. The method of claim 5, wherein forming the second display arrangement is based on the receiving of additional item information.

7. The method of claim 1, further comprising presenting one or more user interface controls at the display, the one or more user interface controls for selecting the arrangement criteria.

8. The method of claim 7, wherein receiving a user request to change the first display arrangement of the plurality of receipt items comprises receiving a selection of arrangement criteria at the one or more user interface controls.

9. The method of claim 1, wherein receiving a user request to change the first display arrangement of the plurality of receipt items comprises receiving a request for one or more of: sorting and grouping the plurality of receipt items.

10. A computer program product for use at a mobile device, the computer program product for implementing a method of arranging the display of receipt items from one or more digital receipts, the computer program product comprising computer-executable instructions that, when executed at a processor, cause the mobile device to perform the method, including the following:
responding to actions requested by a user of the mobile device;
retrieving a plurality digital receipts stored in a memory system of the mobile device upon receiving a request from the user, the request to display receipt item information from a plurality of digital receipts, the digital receipts including a plurality of receipt items having receipt item information stored in a memory system of the mobile device;
displaying the receipt item information in a first display arrangement of receipt items;
rearranging the receipt item information upon receiving a user request, and forming a second display arrangement of receipt items based on arrangement criteria for receipt items of the plurality of digital receipts; and
displaying the second display arrangement of receipt items on a display of the mobile device.

11. The computer program product of claim 10, wherein arrangement criteria includes an arrangement criteria for grouping receipt items based on receipt item information and forming groups based on receipt item information.

12. The computer program product of claim 10, wherein the receipt item information is item department.

13. The computer program product of claim 10, wherein the receipt item information is item price.

14. The computer program product of claim 10, wherein the user requests from a merchant an update of digital receipts associated with an application identifier.

15. A computer system having a processor, system memory, and a display, the system comprising:
a communication module configured to request and receive digital receipts, wherein digital receipts are associated with a customer fingerprint and digital receipts include receipt items, each receipt item including item information for a purchased item;
a storage module of the system memory for storing digital receipts and item information of the digital receipts;
a user interface module configured to present user interface controls and receive a user request in response to selection of user interface controls; and
an arrangement module configured rearrange the presentation of receipt items at the computer system from a first display arrangement to a second different display arrangement in response to arrangement criteria selected through the user interface.

16. The computer system of claim 15, wherein the item information includes for each item a date of purchase and an item price, and the arrangement module arranges the receipt items according to item price.

17. The computer system of claim 15, wherein the receipt information includes department identifiers and, and the arrangement module arranges the receipt items according to department identifiers and the second display arrangement has items in groups corresponding to department identifiers.

18. The computer system of claim 15, wherein the arrangement module is further configured to present one or more user interface controls at the display, the one or more user interface controls for selecting the arrangement criteria.

19. The computer system of claim 18, wherein the arrangement module is further configured to receive a user request to change the first display arrangement of the plurality of receipt items, including receiving a selection of arrangement criteria at the one or more user interface controls.

20. The computer system of claim 19, wherein the arrangement module being configured to receive a user request to change the first display arrangement of the plurality of receipt items comprises the arrangement module being configured to receive a request for one or more of: sorting and grouping the plurality of receipt items.
